(19) United States
(12) Patent Application Publication
(10) Pub. No.: US 2001/0018732 A1
(43) Pub. Date: Aug. 30, 2001

(54) Parallel processor and parallel processing method

(76) Inventors: Junji Nakagoshi, Tokyo (JP); Atsuhiro Suzuki, Tokyo (JP)

Correspondence Address: Mattingly, Stanger & Malur, P.C., 104 East Hume Avenue, Alexandria, VA, 22301, US

(21) Appl. No.: 09/760,295

(22) Filed: Jan. 18, 2001

(30) Foreign Application Priority Data
Jan. 21, 2000 (JP) 2000-017738

(51) Int. Cl. G06F 15/76

(52) U.S. Cl. 712/11; 709/201; 709/230

(57) ABSTRACT

A transmitting circuit splits data to be transmitted into a number of pieces of smaller data, generating packets each used for containing one of the pieces of smaller data with an amount determined by the size of the packet and adding information to a header of each of the packets prior to transmission of the packet to a receiving circuit. Each time the receiving circuit receives any of the packets, the receiving circuit uses the information included in header of the packet to determine whether the packet has been received normally.

### BACKGROUND OF THE INVENTION

1. Field of the Invention

The present invention relates to a method of transferring data among nodes in a parallel processor. More particularly, the present invention relates to a parallel processor wherein packets are exchanged through a network.

2. Related Art

As disclosed in Japanese Patent Laid-open No. H7-262152, the conventional parallel processor comprises a plurality of nodes, which are connected to a network and each have an instruction processor, a local memory, a transmitting circuit and a receiving circuit.

The transmitting circuit comprises:

a transmission sequencer which is a circuit for controlling the whole transmitting circuit;

a TCWB (Transfer Control Word Block) address register used for storing an address written into the register by the instruction processor, in which the address stored in the TCWB address register is the address of a location in the local memory which is used for storing a TCWB created by the instruction processor;

a TCWB buffer used for temporarily holding a TCWB read out from a location in the local memory;

a transmission interrupt circuit for controlling generation of transmission interrupts;

a transmission FIFO (First In First Out) data buffer which is a memory serving as a buffer used for storing pieces of data read out from the local memory to be transmitted to the network;

a transmission DMAC (Direct Memory Access Controller) which is a controller for controlling operations to read out and write data from and into the local memory; and

a packet builder which is a circuit for filling a packet header with information extracted from the TCWB buffer, fills a packet body with data fetched from the transmission FIFO data buffer and transmits a packet comprising the packet header and the packet body to the network.

On the other hand, the receiving circuit comprises:

a reception sequencer which is a circuit for controlling the entire receiving circuit;

a packet header buffer used for temporarily storing the header of a received packet;

a reception interrupt circuit for controlling generation of interrupts to the instruction processor in accordance with the packet header;

a reception FIFO data buffer which is a memory serving as a buffer used for storing pieces of data received from the network to be written into the local memory;

a reception DMAC which is a controller for controlling operations to read out and write data from and into the local memory; and

a packet interpreter which is a unit for removing a packet start code from a packet received from the network to store the packet header and the packet body into the packet header buffer and the reception FIFO data buffer respectively.

In such a configuration, transmission operations are carried out as follows. First of all, the instruction processor creates a TCWB in the local memory for a packet to be transmitted. The TCWB includes a packet type, a command-chain enable bit, a transmission-interrupt enable bit, a reception-interrupt enable bit, a transmitting data address, a transmitting data length, a receiving node number, a receiving flag address, a transmitting flag address and a command-chain address. If a next TCWB linked to the current TCWB in a chain exists, the address of the next TCWB is included in the command-chain address field of the TCWB and the command-chain enable bit is set. In order to start a transmission process, the instruction processor stores the address of the TCWB in the TCWB address register employed in the transmitting circuit.

As the address of the TCWB is stored in the TCWB address register, the transmission sequencer reads out the TCWB from a location in the local memory. The location in the local memory is indicated by the address of the TCWB and the address is stored in the TCWB address register. The TCWB read out from the local memory is stored in the TCWB buffer. The transmission sequencer then instructs the transmission DMAC to read out data to be transmitted from a location in the local memory. The location is indicated by the transmitting data address in the TCWB. The length of data to be read out by the DMAC is indicated by the transmitting data length in the TCWB. Instructed by the transmission sequencer, the DMAC reads out the data to be transmitted from the local memory and stores the data into the FIFO data buffer. Then, the transmission sequencer instructs the packet builder to start transmission.

The packet builder creates a packet header from a start code of a packet and the TCWB stored in the TCWB buffer, transmitting the packet header to the network. After the transmission of the packet header is completed, the packet builder reads out the data to be transmitted from the transmission FIFO buffer and creates a packet body from the data. The packet body is then transmitted to the network.

By carrying out the above operations, transmission of 1 packet is completed. If the command-chain enable bit is set, a next TCWB is read out from a location in the local memory and a packet based on the next TCWB is transmitted to the network in the same way as the preceding TCWB. The location in the local memory is indicated by the command-chain address included in the preceding TCWB.

On the other hand, reception operations are carried out as follows. The packet interpreter receives a packet from the network and removes a packet start code from the packet. Then, the packet interpreter stores the packet header and the packet body into the packet-header buffer and the reception FIFO data buffer respectively. Subsequently, the packet interpreter issues a write command to the reception DMAC to read out received data from the reception FIFO buffer and write the data into a location in the local memory. The location is indicated by a receiving data address in the packet header stored in the packet-header buffer and the length of the received data is indicated by the received data length also included in the packet header. The DMAC writes the received data into the local memory accordingly. After all the received data has been written into the local memory, the packet interpreter instructs the reception DMAC to write a receiving flag into a location in the local memory. The location is indicated by a receiving flag address in the packet header stored in the packet-header buffer. In this way, the operations to receive a packet are completed.

The basic configurations and operations for exchanging data among instruction processors have been explained above. As another disclosure, there is Japanese Patent Laid-open No. H8-287031. In accordance with this disclosure, data to be transmitted to another processor is split into a plurality of blocks each further split into a plurality of packets. A reception-end interrupt flag in the header of the last packet among the packets constituting each block is set at “1”. On the other hand, the reception-end interrupt flag in the header of each other packet constituting the block is set at “0”. When a receiving processor receives a packet with the reception-end interrupt flag in the header thereof set at “1”, the processor generates an interrupt to a CPU thereof.

First of all, consider a parallel processor wherein a packet based on information specified by the conventional TCWB is transmitted to a receiving node. In this case, in order to transmit data of a large amount indicated by the transmitting data length in the TCWB, a long packet is required. If data of such a large amount indicated by the transmitting data length in the TCWB is transmitted as 1 packet, the following problems may arise.

Assume for example that 4 nodes, namely, nodes 0 to node 3, transmit data at the same time. To be more specific, node 0 transmits data to node 1, node 1 transmits data to node 2, node 2 transmits data to node 3 and node 3 transmits data to node 0. The transmitted data is referred to as packet A. Before a transmission of packet A, a transmitting node receives a transmission permit packet from the receiving node. Referred to as packet B, the transmission permit packet indicates that the transmitting node is allowed to transmit packet A to the receiving packet. The transmitting node transmits packet A to the receiving node only after verifying the reception of packet B.

In accordance with such a transfer method, processing would naturally proceed as expected. However, assume that node 2 has gotten out off synchronization with pieces of processing carried out by other nodes due to, for example, implementation of an I/O interrupt handling in node 2. As a result, node 2 transmits packet B serving as a transmission permit packet late to node 1. In the mean time, processing at the other nodes proceeds normally. For example, node 1 is receiving packet A from node 0 after transmitting packet B serving as a transmission permit packet to node 0. In this condition, processing at node 2 also proceeds. Since node 2 transmits packet B to node 1 late as described above, however, node 1 has already entered a state of receiving packet A from node 0 by the time node 2 transmits packet B to node 1 so that node 1 is not readily aware of the arrival of packet B transmitted by node 2. It is not until the completion of the reception of packet A from node 0 that node 1 recognizes the arrival of packet B from node 2, and it is not until the recognition of the arrival of packet B that node 1 transmits packet A to node 2. All nodes should naturally transfer packet A at the same time so that transmission of packets is completed within the time it takes to transfer packet A. Since node 1 transfers packet A to node 2 late, however, the time to complete the transmission of all packets by all nodes is increased by up to a time to transmit 1 packet. As a result, there is raised a problem of a longer communication time.

In order to solve this problem, in the case of the conventional parallel processor, data to be transmitted by using packet A is split into a plurality of pieces of data based on the same plurality of TCWBs and, in each of the TCWBs, the command-chain enable bit is set. The data is thus transmitted by using a plurality of packets A each conveying a smaller amount of data. As a result, since the time it takes to complete reception of 1 smaller packet A is shorter, in the above example, the delay of the recognition of the arrival of packet B from node 2 by node 1 caused by the reception of packet A by node 1 from node 0 becomes shorter.

In this case, however, there are required an additional overhead to create the additional TCWBs and an additional overhead to read out the additional TCWBs for creating the additional packets. As a result, there is raised another problem of inability to process transmission of data at a high speed.

In accordance with the method disclosed in Japanese Patent Laid-open No. H8-287031 whereby data to be transmitted to another processor is split into a plurality of packets, the other processor may not normally receive a middle packet in the course of transmission because of some reasons. In this case, nevertheless, the transmission is incorrectly regarded as a normal transmission if the reception-end interrupt flag in the header of the last packet is set at “1”.

### BRIEF SUMMARY OF THE INVENTION

In order to solve the problems described above, it is an object of the present invention to provide a parallel processor, in which data to be transmitted is split into packets each having a maximum permissible length to be transmitted to an instruction processor at a receiving node and, each time a receiving node receives a packet, the receiving node checks information included in the header of the packet for indicating whether the packet has arrived normally at the receiving node.

### BRIEF DESCRIPTION OF THE SEVERAL VIEWS OF THE DRAWING

FIG. 1 is a diagram showing the configuration of a first parallel processor of the present invention;

FIG. 2 is diagrams each showing a packet format adopted by the first parallel processor of the present invention;

FIG. 3 is a diagram showing the configuration of a second parallel processor of the present invention;

FIG. 4 is a diagram showing a packet format adopted by the second parallel processor of the present invention; and

FIG. 5 is a diagram showing a division packet counter employed by the second parallel processor of the present invention.

### DETAILED DESCRIPTION OF THE INVENTION

Preferred embodiments of the present invention are explained by referring to the diagrams. There are some methods for exchanging data among nodes in a parallel processor. In order to allow data to be exchanged smoothly, the following method is adopted. Before data is transferred, information required for transmitting and receiving data is exchanged in advance between transmitting and receiving nodes. Concretely, the transmitting node obtains an address of a location for storing data transmitted to a receiving node in the receiving node and addresses of locations for storing a variety of flags in the receiving node before transmitting the data. The receiving node allocates a region for storing received data and a region for storing a variety of flags in advance so that the data can be received with a high degree of reliability. The following description is based on the above-described assumption.

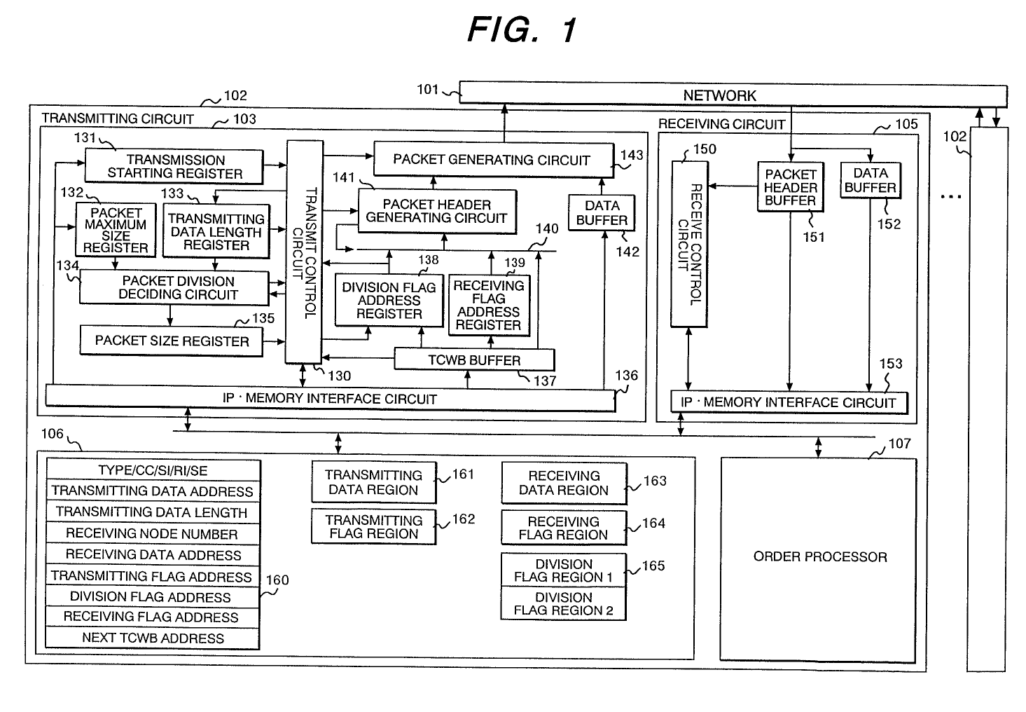

FIG. 1 is a diagram showing the configuration of a parallel processor implemented by a first embodiment of the present invention. Numeral 102 denotes a node of the parallel processor. In the parallel processor shown in FIG. 1, there are only 2 nodes. Numeral 101 denotes a network connecting the nodes 102 to each other. Data is exchanged between the nodes 102 by way of the network 101.

The node 102 comprises a transmitting circuit 103, a receiving circuit 105, a memory 106 and an instruction processor 107. The transmitting circuit 103 is a circuit for outputting data to the network 101. The receiving circuit 105 is a circuit for receiving packets transmitted by way of the network 101. The memory 106 is a storage means for storing instructions and data. The instruction processor 107 is a unit for executing instructions. The memory 106 comprises a TCWB (transfer control word block) 160, a transmitting data region 161, a transmitting flag region 162, a receiving data region 163, a receiving flag region 164 and a division flag region 165. The TCWB 160 is a region for storing information required for exchanging data between the nodes 102.

The transmitting circuit 103 comprises the following components. A transmit control circuit 130 is a circuit for controlling all transmission processing. A transmission starting register 131 is a register for starting transmission of data. That is, transmission of data is activated when the address of a prepared TCWB 160 is stored in the transmission starting register 131. A packet maximum size register 132 is a register for holding a maximum size of a packet to be transmitted. The instruction processor 107 is capable of setting any arbitrary value in the packet maximum size register 132 as a maximum size of a packet to be transmitted. A transmitting data length register 133 is a register for holding the length of data to be transmitted data. This length is specified in the TCWB 160 prepared in the memory 106. Data may be transmitted by splitting the data into packets. When transmission of a packet is completed, the contents of the packet maximum size register 132 are subtracted from the contents of the transmitting data length register 133. A packet division deciding circuit 134 determines whether data to be transmitted needs to be split into packets. The determination is based on comparison of the contents of the packet maximum size register 132 with the contents of the transmitting data length register 133. A packet size register 135 is a register for holding the size of a packet to be transmitted to the network. The size is set by the packet division deciding circuit 134. An IP (Instruction Processor) & memory-I/F (interface) circuit 136 is an interface between the transmitting circuit 103 and the memory 106. To put it in detail, when the instruction processor 107 controls operations to read out and write data from and into a variety of registers in the transmitting circuit 103 or carries out transmission processing, the transmitting circuit 103 controls operations to read out and write data from and into the memory 106. A TCWB buffer 137 is a buffer for holding the TCWB 160 read out by the transmit control circuit 130 from the memory 106. A division flag address register 138 is a register for holding the address of a division flag in the receiving node. Such an address is included in the TCWB 160. Each time a packet is transmitted, the address of a division flag region in the receiving node, that is, the contents of the division flag address register 138, are updated and added to the header of a split packet. A division flag in the receiving node is set when a middle packet of data being transmitted is correctly received by the receiving node. A receiving flag address register 139 is a register for holding the address of a receiving flag in the receiving node. Such an address is included in the TCWB 160. A division flag in the receiving node is set when the last packet of data being transmitted is correctly received by the receiving node. A selector 140 is a means used for selecting the TCWB buffer 137, the division flag address register 138 or the receiving flag address register 139 in a process of creating the header of a packet. It should be noted that, in the case of a middle packet of data being transmitted, the address of the division flag held in the division flag address register 138 is selected. In the case of the last packet of data being transmitted, on the other hand, the address of the receiving flag held in the receiving flag address register 139 is selected. A packet header generating circuit 141 is a circuit for generating the header of a packet by inputting data output by the selector 140 in a process of transmitting the packet. A data buffer 142 is a buffer for holding data to be transmitted. The data to be transmitted is read out from the memory 106 by the transmit control circuit 130. A packet generating circuit 143 is a circuit for generating a packet including the header of the packet generated by the packet header generating circuit 141 and the data stored in the data buffer 142 in a process of transmitting the packet.

The memory 106 comprises the TCWB 160, a transmitting data region 161 and a transmitting flag region 162 for packet-transmission use.

The receiving circuit 105 comprises a receive control circuit 150, a packet-header buffer 151, a data buffer 152 and an IP & memory-I/F circuit 153. The receive control circuit 150 is a circuit for controlling whole reception processing. The packet-header buffer 151 is a buffer used for holding the header of a packet received from the network 101. The data buffer 152 is a buffer used for holding transmitted data included in a packet received from the network 101. The IP & memory-I/F circuit 153 is a circuit for controlling a write operation on the memory 106 in a process carried out by the receive control circuit 150 to write the transmitted data held in the data buffer 152 into the memory 106.

The memory 106 comprises a receiving data region 163, a receiving flag region 164 and a division flag region 165 for packet-reception use.

The following description explains operations to transmit and receive packets in such a configuration. Prior to activation of a packet transmission, the instruction processor 107 sets a proper maximum size of a packet in the packet maximum size register 132 employed in the transmitting circuit 103 by way of the IP & memory-I/F circuit 136. Typical values of the maximum size are 4 Kbytes and 8 Kbytes.

Then, a TCWB 160 is prepared in the memory 106. The TCWB 160 includes pieces of information stored in fields including in a TYPE field, a CC field, an SI field, an RI field, an SE field, a transmitting data address register field, a transmitting data length field, a transmitting flag address field, a receiving node number field, a receiving data address field, a division flag address field, a receiving flag address field and a next-TCWB-address field. The TYPE field is a field indicating the type of a packet to be transmitted and identifying a technique of processing reception or the like. The CC field is a field indicating whether the TCWB 160 is linked to a next TCWB in a chain. The SI field is a field indicating whether to inform the instruction processor 107 by using an interrupt that a transmission of all data indicated by the length of data to be transmitted has been completed upon completion of the transmission. The length of data to be transmitted is specified in the transmitting data length field of the TCWB 160. The RI field is a field indicating whether to inform the instruction processor 107 employed in the receiving node 102 by using an interrupt that a reception of all data indicated by the length of data to be transmitted has been completed upon completion of the reception. The length of data to be transmitted is specified in the transmitting data length field of the TCWB 160. The SE field is a field indicating whether to transmit data by splitting the data to be transmitted into a plurality of packets in case the length of data to be transmitted in the transmitting data length field of the TCWB 160 exceeds the contents of the packet maximum size register 132. The number of split packets is determined from the length of data to be transmitted and the contents of the packet maximum size register 132. The transmitting data address register field is a field showing the start address of the transmitted data region 161 in the memory 106. The transmitting data length field is a field indicating the length of data to be transmitted. The transmitting flag address field is a field indicating whether to record a completion of a transmission of all data indicated by the length of data to be transmitted into the transmitting flag region 162 in the memory 106. In this way, the instruction processor 107 is capable of determining whether such a transmission has been completed by referring to the transmitting flag region 162. The length of data to be transmitted is specified in the transmitting data length field of the TCWB 160. The receiving node number field is a field specifying a node to serve as a recipient of the data to be transmitted. The receiving data address field is a field indicating the start address of the receiving data region 163 in the memory 107 employed in the receiving node 102. The receiving data region 163 is used for storing the transmitted data received by the receiving node 102. The division flag address field is a field indicating an address of a location in the division flag region 165 in the memory 106 employed in the receiving node 102. Such a location is allocated to each split packet. A completion of a reception of a split packet is recorded at the location allocated to the packet as information for the receiving node 102. In this way, the receiving node 102 is capable of determining whether a split packet has been received normally. The receiving flag address field is a field indicating whether to record a completion of a reception of all data indicated by the length of data to be transmitted into the receiving flag region 164 in the memory 106 employed in the receiving node 102. In this way, the instruction processor 107 employed in the receiving node 102 is capable of determining whether such a reception has been completed by referring to the receiving flag region 164. The length of data to be transmitted is specified in the transmitting data length field of the TCWB 160. The next-TCWB-address field is a field, which is used for showing the address of a next TCWB 160 in case the CC field indicates that this TCWB 160 is linked to a next TCWB in a chain.

After preparing a TCWB 160, the instruction processor 107 writes the address of the TCWB 160 into the transmission starting register 131 employed in the transmitting circuit 103 by way of the IP & memory-I/F circuit 136.

The transmitting circuit 103 interprets the operation to write the address into the transmission starting register 131 as activation of a transmission. In this case, the transmit control circuit 130 reads out the TCWB 160 from an address indicated by the transmission starting register 131. The TCWB 160 read out from the memory 106 is stored into the TCWB buffer 137 by way of the IP & memory-I/F circuit 136.

In order to explain concrete operations of the embodiment, assume that the packet maximum size register 132 is set at 4 Kbyte and the transmitting data length field of the TCWB 160 is set at 10 Kbyte. In the following description of the operations, it is also assumed that the SE field is set to indicate a transmission of data by splitting the data to be transmitted into a plurality of packets in case the length of data to be transmitted in the transmitting data length field of the TCWB 160 exceeds the contents of the packet maximum size register 132. In addition, let the size of each of transmitting flag region 162, receiving flag region 164 and division flag region 165 in the memory 106 be 8 bytes.

The transmit control circuit 130 reads out the entire TCWB 160 from the memory 106 and stores the TCWB 160 into the TCWB buffer 137. Then, the transmit control circuit 130 transfers a division flag address from the TCWB buffer 137 to the division flag address register 138. In the same way, the transmit control circuit 130 transfers a receiving flag address and the length of the data to be transmitted from the TCWB buffer 137 to the receiving flag address register 139 and the transmitting data length register 133 respectively. The transmit control circuit 130 also reads out the transmitting data address field from the TCWB buffer 137 and holds the contents of the field internally. In addition, the transmit control circuit 130 also reads out the receiving data address field from the TCWB buffer 137 and holds the contents of the field internally. The transmit control circuit 130 also reads out the SE field from the TCWB buffer 137 and supplies the contents of the SE field to the packet division deciding circuit 134. Then, the transmit control circuit 130 requests the packet division deciding circuit 134 to determine whether the data to be transmitted should be split into packets.

At the request made by the transmit control circuit 130, the packet division deciding circuit 134 determines whether the data to be transmitted should be split into packets on the basis of the contents of the SE field, the transmitting data length register 133 and the packet maximum size register 132. Since the SE field has been set to indicate a transmission of data by splitting the data to be transmitted into a plurality of packets in case the length of data to be transmitted stored in the transmitting data length register 133 exceeds the maximum size of a packet stored in the packet maximum size register 132, and former is indeed greater than the later, the packet division deciding circuit 134 determines that the data to be transmitted is split into packets. The packet division deciding circuit 134 then determines a proper size of each split packet and stores the size in the packet size register 135. Typically, the contents of the packet maximum size register 132 are merely used as the size of a split packet. In this example, since the 10-Kbyte length of the data to be transmitted stored in the transmitting data length register 133 exceeds the 4-Kbyte maximum size of a packet snored in the packet maximum size register 132, the packet size register 135 is set at 4 Kbyte. The packet division deciding circuit 134 also informs the transmit control circuit 130 that, since the data to be transmitted is split into a plurality of packets, a packet following this current packet remains to be transmitted after the transmission of the current packet.

As the packet size is set in the packet size register 135, the transmit control circuit 130 reads out the transmitting data address field from the TCWB buffer 137 and reads out the data to be transmitted from transmitting data region 161 indicated by the contents of the transmitting data address field. The location of transmitting data region 161 in the memory 106 is indicated by the address in the field whereas the size of data to be readout from transmitting data region 161 is indicated by the packet size register 135. The data read out from transmitting data region 161 of the memory 106 is supplied to the data buffer 142 by way of the IP & memory-I/F circuit 136.

While the data to be transmitted is being read out from transmitting data region 161 of the memory 106, the transmit control circuit 130 requests the packet generating circuit 143 and the packet header generating circuit 141 to generate a packet and the header of the packet respectively, and then requests the packet generating circuit 143 to transmit the generated packet to the network 101.

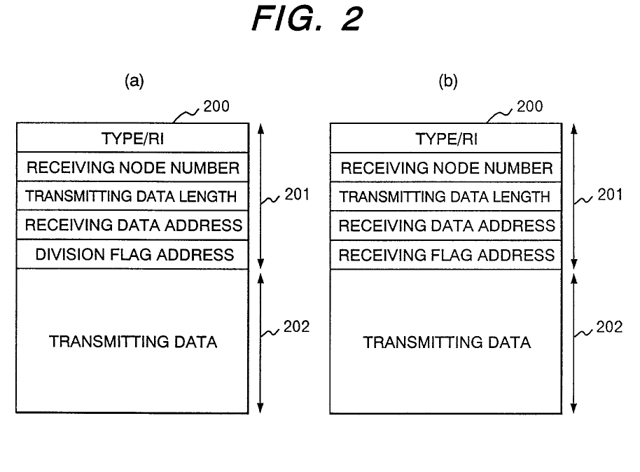

FIG. 2 is diagrams each showing the format of a packet. To be more specific, FIG. 2A shows a packet 200 comprising a header 201 and transmitted data 202. The packet header 201 comprises pieces of information stored in a TYPE field, an RI field, a receiving node number field, a transmitting data length field, a receiving data address field and a division flag address field, which are used for storing the same information as the counterpart fields in the TCWB 160. The TYPE field is a field indicating the type of a packet to be transmitted and identifying a technique of processing reception or the like. The RI field is a field indicating whether to inform the instruction processor 107 by using an interrupt that a reception of the packet 200 has been completed upon completion of the reception. The receiving node number field is a field specifying a node to serve as a recipient of the packet 200. The transmitting data length field is a field indicating the length of the transmitted data 202 of the packet 200. The receiving data address field is a field indicating the start address of the receiving data region 163 in the memory 107 employed in the receiving node 102. The receiving data region 163 is used for storing the data 202. The division flag address field is a field indicating an address of a location in the division flag region 165 in the memory 106 employed in the receiving node 102. A completion of a reception of a split packet 200 is recorded at the location as information to be referred to by the receiving node 102.

In order to transmit the packet 200 to the network 101, the packet header generating circuit 141 receives the address of the transmitted data 202 in the receiving node 102 from the transmit control circuit 130 to set the length of the transmitted data 202 and the address of the transmitted data 202 in the transmitting data length field and the receiving data address field of the packet header 201 respectively. As for the TYPE field and the receiving node number field of the packet header 201, the packet header generating circuit 141 reads out the respective pieces of information from the TCWB buffer 137 through the selector 140 and sets them in the fields. Since the packet division deciding circuit 134 has informed the transmit control circuit 130 that a packet following this current packet remains to be transmitted, the transmic control circuit 130 also drives the packet header generating circuit 141 to acquire the contents of the division flag address register 138 through the selector 140 and set the contents in the receiving flag address field of the packet header 201. Even though the RI field of the TCWB 160 is set, the packet header 201 being created is not the header of the last split packet. Thus, the RI field of the packet header 201 is reset to generate no interrupt to the instruction processor 107 employed in the receiving node 102. The packet header generating circuit 141 finally supplies the packet header 201 to the packet generating circuit 143.

The packet generating circuit 143 transmits the packet header 201 created by the packet header generating circuit 141 to the network 101. As the transmission is completed, the packet generating circuit 143 reads out the data to be transmitted from the data buffer and transmits the data to the network 101.

Since the packet division deciding circuit 134 has informed the transmit control circuit 130 that another packet following this current packet remains to be transmitted, the transmit control circuit 130 subtracts the contents of the packet maximum size register 132 from the contents of the transmitting data length register 133 and sets the difference obtained as a result of the subtraction in the transmitting data length register 133 when the packet generating circuit 143 completes the transmission of the current split packet. In addition, the transmit control circuit 130 also updates the contents of the transmitting data address field and the receiving data address field, which are held internally, by adding the contents of the packet maximum size register 132 to the contents of the fields. The contents of the division flag address register 138 is also updated by adding the size of receiving flag region 165 to the contents and storing back the sum into the division flag address register 138. In the case of this embodiment, the size is 8 bytes as described earlier. At this point, the transmission of the first split packet is completed.

Then, the transmit control circuit 130 requests the packet division deciding circuit 134 to determine whether the data remaining to be transmitted by means of a second split packet should be again split into packets. At the request made by the transmit control circuit 130, the packet division deciding circuit 134 again determines whether the data to be transmitted should be split into packets on the basis of the contents of the transmitting data length register 133 and the packet maximum size register 132. Since the length of data to be transmitted stored in the transmitting data length register 133 still exceeds the maximum size of a packet stored in the packet maximum size register 132 in the transmission of the second spilt packet, the packet division deciding circuit 134 determines that the data to be transmitted is again split into packets. The packet division deciding circuit 134 then determines to use the contents of the packet maximum size register 132 as a proper size of the second split packet and stores the size in the packet size register 135. In this example, since the updated 6-Kbyte length of the data to be transmitted stored in the transmitting data length register 133 exceeds the 4-Kbyte maximum size of a packet stored in the packet maximum size register 132, the packet size register 135 is set at 4 Kbyte. The packet division deciding circuit 134 also informs the transmit control circuit 130 that, since the data to be transmitted is split into a plurality of packets, a packet following this current packet exists. Concretely, another split packet still remains to be transmitted after the transmission of this current packet.

When the packet size is set in the packet size register 135, the transmit control circuit 130 carries out the operations described above. When the packet generating circuit 143 completes the transmission of the second split packet, the packet division deciding circuit 134 has informed the transmit control circuit 130 that the last packet following this second split packet still remains to be transmitted after the transmission of this second split packet. Thus, the transmit control circuit 130 updates the contents of the transmitting data length register 133, the transmitting data address field, the receiving data address field and the division flag address register 138 in the same way as described above. In this way, the transmission of the 2 split packets is completed.

FIG. 2B is a diagram showing the format of the last split packet. The only difference from the format shown in FIG. 2A is that the division flag address field of the format shown in FIG. 2A is replaced by a receiving flag address field in the format shown in FIG. 2B.

Then, the transmit control circuit 130 requests the packet division deciding circuit 134 to determine whether the data remaining to be transmitted by means of a third split packet should be again split into packets. At the request made by the transmit control circuit 130, the packet division deciding circuit 134 again determines whether the data to be transmitted should be split into packets on the basis of the contents of the transmitting data length register 133 and the packet maximum size register 132. Since the length of data to be transmitted stored in the transmitting data length register 133 is now smaller than the maximum size of a packet stored in the packet maximum size register 132 in the transmission of the third split packet, however, the packet division deciding circuit 134 determines that the data to be transmitted is not split into packets. In this case, the packet division deciding circuit 134 determines to use the contents of the transmitting data length register 133 as a proper size of the third split packet and stores the size in the packet size register 135. In this example, since the updated 2-Kbyte length of the data to be transmitted stored in the transmitting data length register 133 is smaller than the 4-Kbyte maximum size of a packet stored in the packet maximum size register 132, the packet size register 135 is set at 2 Kbyte. The packet division deciding circuit 134 also informs the transmit control circuit 130 that, since the data to be transmitted is not split into a plurality of packets, no packet following this current packet remains to be transmitted after transmission of this current packet.

When the packet size is set in the packet size register 135, the transmit control circuit 130 reads out the transmitting data address field from the TCWB buffer 137 and reads out the data to be transmitted from transmitting data region 161 indicated by the transmitting data address field. The location of transmitting data region 161 in the memory 106 is indicated by the address described in the transmitting data address field whereas the size of data to be read out from transmitting data region 161 is indicated by the packet size register 135. The data read out from transmitting data region 161 of the memory 106 is supplied to the data buffer 142 by way of the IP & memory-I/F circuit 136. While the data to be transmitted is being read out from transmitting data region 161 of the memory 106, the transmit control circuit 130 requests the packet generating circuit 143 and the packet header generating circuit 141 to generate a packet and the header of the packet respectively, and then requests the packet generating circuit 143 to transmit the generated packet to the network 101.

In the same way as the operations described earlier, the packet header generating circuit 141 sets pieces of information in a TYPE field, an RI field, a receiving node number field, a transmitting data length field, a receiving data address field and a receiving flag address field of the packet header 201. Since the packet division deciding circuit 134 has informed the transmit control circuit 130 that no packet following this current packet remains to be transmitted after transmission of this current packet, the transmit control circuit 130 drives the packet header generating circuit 141 to acquire the contents of the receiving flag address register 139 through the selector 140 and set the contents in the receiving flag address field of the packet header 201. Since the RI field of the TCWB 160 is set and the packet header 201 being created is the header of the last split packet, the RI field of the packet header 201 is set to generate an interrupt to the instruction processor 107 employed in the receiving node 102 upon reception of this last split packet 200. The created packet header 201 is shown in FIG. 2B. The packet header generating circuit 141 finally supplies the packet header 201 to the packet generating circuit 143. The packet generating circuit 143 transmits the packet header 201 created by the packet header generating circuit 141 to the network 101. As the transmission is completed, the packet generating circuit 143 reads out the data to be transmitted from the data buffer 142 and transmits the data to the network 101.

As the packet generating circuit 143 completes the transmission of the last split packet, the transmit control circuit 130 informs the instruction processor 107 that all data to be transmitted as indicated by the TCWB 160 has been output to the network 101 by recording a transmitting flag in the memory 106 at an address indicated by the transmitting flag address field in the TCWB buffer 137. If the SI field of the TCWB 160 is set, the instruction processor 107 is also notified of the completion of the transmission of all the data to be transmitted by an interrupt. By carrying out the operations described above, all the data to be transmitted as indicated by the TCWB 160 is output to the network 101 and the transmission processing is ended.

If the CC field of this TCWB 160 is set to indicate that this TCWB 160 is linked to a next TCWB 160 in a chain, the address of the next TCWB 160 is read out from the next-TCWB-address field in the TCWB buffer 137 upon completion of the transmission of the data to be transmitted as indicated by this TCWB 160 and the operations described above are repeated.

Next, reception processing is explained. When a packet 200 is received from the network 101, the header 201 of the packet 200 is stored into the packet-header buffer 151 and the transmitted data 202 is stored in the data buffer 142. The receive control circuit 150 then reads out the receiving data address field from the packet-header buffer 151 and stores the data 202 in the memory 106 at an address indicated by the field. The amount of the data 202 stored in the memory 106 is indicated by the transmitting data length field held in the packet-header buffer 151. Then, the receive control circuit 150 stores a division flag or a receiving flag into the memory 106 at addresses indicated by respectively the division flag address field or the receiving flag address field held in the packet-header buffer 151. If the RI field of the TCWB is set and the packet header 201 being created is the header of the last split packet, the RI field of the packet header 201 is also set. In this case, the receive control circuit 150 generates an interrupt to the instruction processor 107 to inform the instruction processor 107 that the data 202 of all split packets 200 has been stored in the memory 106.

In the above description, the length of data to be transmitted specified in the TCWB 160 is assumed to be greater than the contents of the packet maximum size register 132. If the length of data to be transmitted specified in the TCWB 160 is smaller than the contents of the packet maximum size register 132, on the other hand, the data is transmitted by carrying out the same operations as the operations to transmit the last split packet.

Also in the above description, the SE field is assumed to have been set to indicate that data is transmitted by splitting the data to be transmitted into a plurality of packets in case the length of data to be transmitted in the transmitting data length field of the TCWB 160 exceeds the contents of the packet maximum size register 132. It should be noted, however, that the SE field in the TCWB buffer 137 can also be set to indicate that data is to be transmitted by not splitting the data to be transmitted into a plurality of packets even if the length of data to be transmitted in the transmitting data length field of the TCWB 160 exceeds the contents of the packet maximum size register 132. In this case, the packet division deciding circuit 134 merely transfers the contents of the transmitting data length register 133 to the packet size register 135 as they are without comparing the contents of the transmitting data length register 133 with the contents of the packet maximum size register 132. The packet division deciding circuit 134 also informs the transmit control circuit 130 that no subsequent packet remains to be transmitted. The rest is the same as the operations described above.

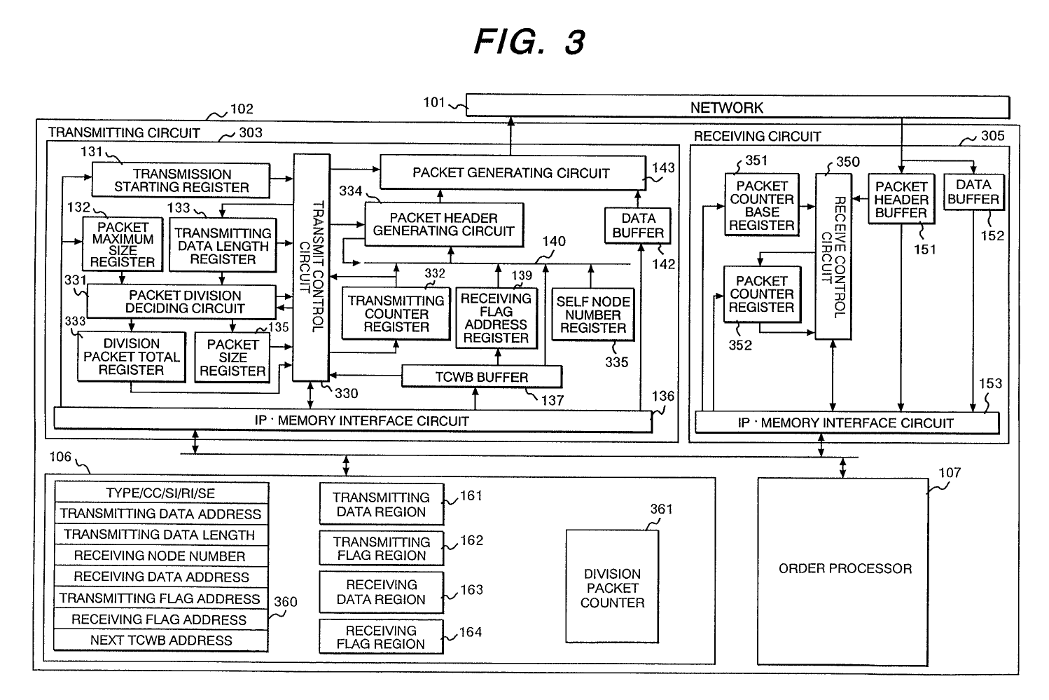

The following description explains the modified embodiment with reference to FIG. 3. In the embodiment described above, the TCWB 160 includes a division flag address field. A division flag stored at an address indicated by the division flag address field is referred to by a receiving node 102 to verify that a split packet has been received normally. Such a division flag is provided for each transmitted split packet by including by the division flag address field in the header of the packet.

The embodiment can be applied to any configuration of the network 101 wherein a plurality of packets is transmitted from a transmitting node to a receiving node as long as no later-transmitted packet passes an earlier-transmitted packet. The embodiment shown in FIG. 3 exemplifies a method adopted by a receiving node 102 to verify that a split packet has arrived at the receiving node 102 normally without providing a division flag field in the TCWB 160.

Even though only one node 102 is shown in FIG. 3, a plurality of nodes 102 shown in the figure is actually connected to a network 101 as is the case with the embodiment described previously. The node 102 comprises a transmitting circuit 303, a receiving circuit 305, a memory 106 and an instruction processor 107. The transmitting circuit 303 is a circuit for outputting data to the network 101. The receiving circuit 305 is a circuit for receiving packets transmitted by way of the network 101. The memory 106 is a storage means for storing instructions and data. The instruction processor 107 is a unit for executing instructions. The memory 106 comprises a TCWB (transfer control word block) 360, a transmitting data region 161, a transmitting flag region 162, a receiving data region 163, a receiving flag region 164 and a division packet counter 361.

The transmitting circuit 303 does not include the division flag address register 138 employed in the embodiment explained previously. Instead, the transmitting circuit 303 has a transmitting counter register 332, a division packet total register 333 and a self-node-number register 335. The rest is the same as the transmitting circuit 103 employed in the embodiment explained previously. The division packet total register 333 is a counter, which is incremented each time a split packet is transmitted and whose contents are added to the header of each packet. The division packet total register 333 is a register for holding the total number of split packets. The self-node-number register 335 is a register for holding the number of the node employing this register 333.

On the other hand, the receiving circuit 305 comprises a packet counter base register 351 and a packet counter entry register 352. The packet counter base register 351 is a register for holding the address of the division packet counter 361. The packet counter entry register 352 is a register for holding a count read out from the division packet counter 361. The rest is the same as the receiving circuit 105 employed in the embodiment explained previously.

Operations carried out by the nodes 102 with the above configuration to transmit and receive packets are explained as follows. Prior to activation of a packet transmission, the instruction processor 107 sets a proper maximum size of a packet in the packet maximum size register 132. Then, a TCWB 360 is prepared in the memory 106. It should be noted that the TCWB 360 is identical with the TCWB 160 except that the TCWB 360 does not include the division flag address field. After preparing a TCWB 160, the instruction processor 107 writes the address of the TCWB 160 into the transmission starting register 131.

The operation to write the address of the TCWB 160 into the transmission starting register 131 causes the transmitting circuit 303 to recognize the activation of the transmission, and the transmit control circuit 330 to read out the TCWB 360 from an address indicated by the transmission starting register 131. The transmit control circuit 330 then writes the TCWB 360 read out from the memory 106 into the TCWB buffer 137.

In order to explain concrete operations of the embodiment, assume that the packet maximum size register 132 is set at 4 Kbyte and the transmitting data length field of the TCWB 360 is set at 10 Kbyte as is the case with the embodiment explained previously. In the following description of the operations, it is also assumed that the SE field is set to indicate a transmission of data by splitting the data to be transmitted into a plurality of packets in case the length of data to be transmitted in the transmitting data length field of the TCWB 360 exceeds the contents of the packet maximum size register 132. In addition, let the size of each of transmitting flag region 162, receiving flag region 164 and division flag region 165 in the memory 106 be 8 bytes.

When the transmit control circuit 330 reads out the entire TCWB 360 from the memory 106 and stores the TCWB 360 into the TCWB buffer 137, first of all, the transmitting counter register 332 is initialized at a zero. Then, the transmit control circuit 130 transfers the address of a receiving flag and the length of data to be transmitted from the TCWB buffer 137 and stores them in the receiving flag address register 139 and the transmitting data length register 133 respectively. The transmit control circuit 330 also reads out the transmitting data address field from the TCWB buffer 137 and holds the contents of the field internally. In addition, the transmit control circuit 330 also reads out the receiving data address field from the TCWB buffer 137 and holds the contents of the field internally.

The transmit control circuit 330 also reads out the SE field from the TCWB buffer 137 and supplies the contents of the SE field to the packet division deciding circuit 331. Then, the transmit control circuit 330 requests the packet division deciding circuit 331 to determine whether the data to be transmitted should be split into packets.

At the request made by the transmit control circuit 330, the packet division deciding circuit 331 carries out the same operations as the embodiment explained previously and sets the packet size register 135 at 4 Kbyte. The packet division deciding circuit 331 also informs the transmit control circuit 330 that a subsequent split packet remains to be transmitted. In addition, the packet division deciding circuit 331 sets the division packet total register 333 at a value equal to (the total number of split packets to be transmitted−1). Concretely, since the packet maximum size register 132 is set at 4 Kbyte and the transmitting data length register 133 is set at 10 Kbyte, the total number of split packets to be transmitted is 3. Thus, the packet division deciding circuit 331 sets the division packet total register 333 at 2, which is equal to (3−1).

As the packet size is set in the packet size register 135, the transmit control circuit 330 reads out the transmitting data address field and reads out the data to be transmitted in the same way as the embodiment explained previously.

While the data to be transmitted is being read out from transmitting data region 161 of the memory 106, the transmit control circuit 330 requests the packet generating circuit 143 and the packet header generating circuit 334 to generate a packet and the header of the packet respectively, and then requests the packet generating circuit 143 to transmit the generated packet to the network 101.

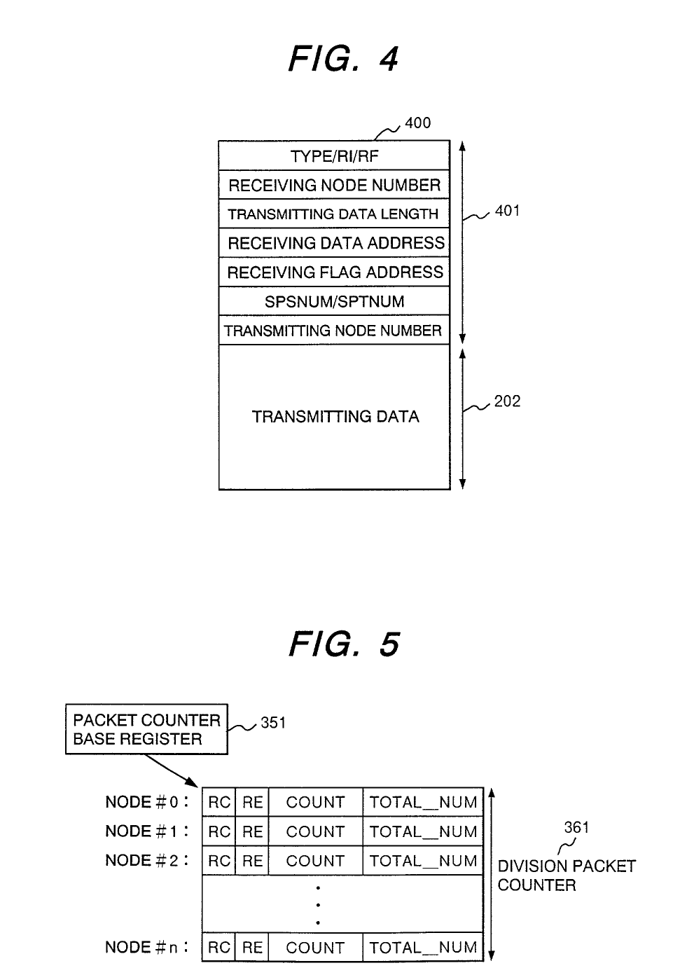

FIG. 4 is a diagram showing the format of the packet. In addition to the fields of the packet header 201 shown in FIG. 2B, the packet header 401 shown in FIG. 4 newly includes a RF field, an SPSNUM field, an SPTNUM field and a transmitting node number field. The RF field is a field used for specifying whether to write a receiving flag at an address in the memory 106 employed in the receiving node 102 upon reception of this split packet 400. The address is specified in the receiving flag address field of the packet header 401. The SPSNUM field is a field describing a sequence number, which is incremented sequentially each time a split packet is transmitted. The SPTNUM field is a field showing the total number of split packets. The SPTNUM field shows a number uniform for all split packets. The transmitting node number field is a field showing the number of a node transmitting this packet.

In order to transmit the packet 400 to the network 101, the packet header generating circuit 334 receives the address of the transmitted data 202 from the transmit control circuit 330 and acquires the length of the transmitted data 202 through the transmit control circuit 330 to set the length and the address of the transmitted data 202 in the transmitting data length field and the receiving data address field of the packet header 401 respectively. As for the TYPE field and the receiving node number field of the packet header 401, the packet header generating circuit 334 reads out the respective pieces of information from the TCWB buffer 137 through the selector 140 and sets them in the fields. The packet header generating circuit 334 reads out the contents of the transmitting counter register 332 and sets the contents in the SPSNUM field of the packet header 401. The packet header generating circuit 334 also reads out the contents of the division packet total register 333 through the transmit control circuit 330 and sets the contents in the SPTNUM field of the packet header 401.

The packet header generating circuit 334 reads out the number of its own node and sets the number in the transmitting node number field of the packet header 401. Even though the RI field of the TCWB 360 is set, the packet header 401 being created is not the header of the last split packet. Thus, the RI field of the packet header 401 is reset to generate no interrupt to the instruction processor 107 employed in the receiving node 102. In addition, since the packet header 401 being created is not the header of the last split packet, the RF field of the packet header 401 is set so as to write no receiving flag at an address in the memory 106. The packet header generating circuit 334 finally supplies the packet header 401 set as described above to the packet generating circuit 143. The packet generating circuit 143 creates a packet 400 including the packet header 401 and transmits the packet 400 to the network 101 in the same way as the embodiment explained previously.

Since the packet division deciding circuit 134 has informed the transmit control circuit 330 that a subsequent packet remains to be transmitted, the packet generating circuit 143 increments the transmitting counter register 332 when the packet generating circuit 143 completes the transmission of the current split packet. Concretely, the transmitting counter register 332 is incremented to 1. Then, the transmit control circuit 130 subtracts the contents of the packet maximum size register 132 from the contents of the transmitting data length register 133 and sets the difference obtained as a result of the subtraction in the transmitting data length register 133. In addition, the transmit control circuit 130 also updates the contents of the transmitting data address field and the receiving data address field, which are held internally, by adding the contents of the packet maximum size register 132 to the contents of the fields. At this point, the transmission of the first split packet is completed.

Then, the transmit control circuit 330 requests the packet division deciding circuit 331 to determine whether the data remaining to be transmitted by means of a second split packet should be again split into packets. At the request made by the transmit control circuit 330, the packet division deciding circuit 331 again determines whether the data to be transmitted should be split into packets on the basis of the contents of the transmitting data length register 133 and the packet maximum size register 132. Since the length of data to be transmitted stored in the transmitting data length register 133 still exceeds the maximum size of a packet stored in the packet maximum size register 132 in the transmission of the second split packet, the packet division deciding circuit 331 determines that the data to be transmitted is again split into packets, and then determines to use the contents of the packet maximum size register 132 as a proper size of the second split packet and stores the size in the packet size register 135. The packet division deciding circuit 331 also informs the transmit control circuit 330 that a subsequent packet following this current packet remains to be transmitted after transmission of this current packet.

It should be noted that the division packet total register 333 is not updated for the second and subsequent split packets. The contents of the division packet total register 333 are uniform for all split packets, being determined to represent a fixed total number of split packets from the length of the data to be transmitted described in the TCWB 360 and the contents of the packet maximum size register 132.

When the packet size is set in the packet size register 135, the transmit control circuit 330 carries out the same operations described above to transmit the second split to the network 101.

When the packet generating circuit 143 completes the transmission of the second split packet, the packet division deciding circuit 331 has informed the transmit control circuit 330 that the last packet following this second split packet still remains to be transmitted after the transmission of this second split packet. Thus, the transmit control circuit 330 updates the contents of the transmitting data length register 133, the transmitting data address field, the receiving data address field and the transmitting counter register 332 in the same way as described above. In this way, the transmission of the 2 split packets is completed.

Then, the transmit control circuit 330 requests the packet division deciding circuit 331 to determine whether the data remaining to be transmitted by means of a third split packet should be again split into packets. At the request made by the transmit control circuit 330, the packet division deciding circuit 331 again determines whether the data to be transmitted should be split into packets on the basis of the contents of the transmitting data length register 133 and the packet maximum size register 132. Since the length of data to be transmitted stored in the transmitting data length register 133 is now smaller than the maximum size of a packet stored in the packet maximum size register 132 in the transmission of the third split packet, the packet division deciding circuit 331 determines that the data to be transmitted is not split into packets, and determines to use the contents of the transmitting data length register 133 as a proper size of the third split packet and stores the size in the packet size register 135. In this example, since the updated 2-Kbyte length of the data to be transmitted is smaller than the 4-Kbyte maximum size of a packet stored in the packet maximum size register 132, the packet size register 135 is set at 2 Kbyte. The packet division deciding circuit 331 also informs the transmit control circuit 330 that no packet following this current packet remains to be transmitted after transmission of this current packet.

When the packet size is set in the packet size register 135, the transmit control circuit 330 reads out the data to be transmitted from transmitting data region 161 in the same way as the embodiment explained previously. While the data to be transmitted is being read out from transmitting data region 161 of the memory 106, the transmit control circuit 330 requests the packet generating circuit 143 and the packet header generating circuit 334 to generate a packet and the header of the packet respectively, and then requests the packet generating circuit 143 to transmit the generated packet to the network 101.

In the same way as the operations described earlier, the packet header generating circuit 334 sets pieces of information in the packet header 401. Since the packet division deciding circuit 331 has informed the transmit control circuit 330 that no packet following this current packet remains to be transmitted after transmission of this current packet, the transmit control circuit 330 also drives the packet header generating circuit 334 to acquire the contents of the receiving flag address register 139 through the selector 140 and set the contents in the receiving flag address field of the packet header 401. In compliance with the setting of the receiving flag address field, the RF field is also set to indicate that a receiving flag be written into an address in the memory 106 employed in the receiving node 102. If the RI field of the TCWB 360 is set, the RI field of the packet header 401 is set to generate an interrupt to the instruction processor 107 employed in the receiving node 102. The packet header generating circuit 334 finally supplies the packet header 401 to the packet generating circuit 143. The packet generating circuit 143 transmits the packet header 401 created by the packet header generating circuit 334 to the network 101. As the transmission is completed, the packet generating circuit 143 reads out the data to be transmitted from the data buffer 142 and transmits the data to the network 101.

As the packet generating circuit 143 completes the transmission of the last split packet 400, the transmit control circuit 330 informs the instruction processor 107 that all data to be transmitted as indicated by the TCWB 360 has been transmitted to the network 101 by recording a transmitting flag in the memory 106 at an address indicated by the transmitting flag address field in the TCWB buffer 137 in the same way as the embodiment explained previously. If the SI field of the TCWB 360 is set, the instruction processor 107 is also notified of the completion of the transmission of all the data to be transmitted by an interrupt. By carrying out the operations described above, all the data to be transmitted as indicated by the TCWB 160 is output to the network 101 and the transmission processing is ended.

Next, reception processing is explained. When a packet is received from the network 101, the header 401 of the packet 400 is stored into the packet-header buffer 151 and the transmitted data 202 is stored in the data buffer 152. The receive control circuit 350 then reads out the receiving data address field from the packet-header buffer 151 and stores the data 202 in the memory 106 at an address indicated by the field.

After the data 202 has been stored, the receive control circuit 350 reads out the number of the transmitting node from the packet-header buffer 151 and adds the number of the transmitting node to the contents of the packet counter base register 351. A sum obtained as a result of the addition is the address of information on the transmitting node. The information is held in an entry of the division packet counter 361. The receive control circuit 350 then reads out the information from the entry of the division packet counter 361 and stores the information in the packet counter entry register 352. It should be noted that the format of the packet counter entry register 352 is the same as the format of each entry in the division packet counter 361.

As shown in FIG. 5, the division packet counter 361 stored in the memory 106 comprises entries each describing information on a transmitting node. An entry allocated to a transmitting node is indicated by the node number assigned to the node. The entries are arranged in an order of increasing node numbers starting from 0. Each entry comprises an RC field, an RE field, a COUNT field and a TOTAL-NUM field. The RC field is a field indicating that all split packets have been received in the expected order. The RE field is a field indicating that all split packets were not received in the expected order. The COUNT field is used for counting the number of split packets received so far. The TOTAL-NUM field is a field showing the total number of split packets supposed to arrive. The packet counter base register 351 indicates the first entry of the division packet counter 361. The first entry is allocated to a transmitting node indicated by a node number of 0. The sum of a node number and the contents of the packet counter base register 351 univocally points to an entry for the transmitting node indicated by the node number.

Each time a packet is received, the SPSNUM field of its header, that is, the sequence number of the packet, is compared with the COUNT field of the entry allocated to the node transmitting the packet to determine whether a previous packet has been missed due an erroneous transmission.

Retrieving an entry for the transmitting node from the division packet counter 361, the receive control circuit 350 also reads out the SPSNUM and SPTNUM fields from the packet-header buffer 151. In the case of a zero SPSNUM field, that is, in the case of the first split packet, the receive control circuit 350 resets the RC, RE and COUNT fields in the packet counter entry register 352 at zeros and sets the TOTAL-NUM field in the packet counter entry register 352 at the same value as the SPTNUM field read out from the packet-header buffer 151. Then, the receive control circuit 350 stores the updated contents of the packet counter entry register 352 back into the entry in the division packet counter 361.

If the SPSNUM field read out from the packet-header buffer 151 is not a zero, on the other hand, the COUNT field in the packet counter entry register 352 is updated by incrementing it by 1. Then, the updated COUNT field is compared with the SPSNUM and SPTNUM fields read out from the packet-header buffer 151.

If results of the comparison are COUNT=SPTNUM and COUNT [symbol] SPSNUM, the receive control circuit 350 stores the updated contents of the packet counter entry register 352 back into the entry in the division packet counter 361 allocated to the transmitting node.

If results of the comparison are COUNT=SPTNUM and COUNT=SPSNUM, the RC field in the packet counter entry register 352 is set at 1 indicating that all split packets have been received in the expected order. In this way, the packet counter entry register 352 indicates the fact that all split packets have been received in the expected order. Then, the receive control circuit 350 stores the updated contents of the packet counter entry register 352 back into the entry in the division packet counter 361 allocated to the transmitting node. Later on, the receive control circuit 350 writes a receiving flag into the memory 106 at an address indicated by the receiving flag address field held in the packet-header buffer 151. In addition, the receive control circuit 350 informs the instruction processor 107 by using an interrupt that all the data 202 has been stored in the memory 106 upon completion of the operation to store the data 202 if the RI field held in the packet-header buffer 151 is set to request such an interrupt.

If a result of the comparison is COUNT [symbol] SPSNUM, the RE field in the packet counter entry register 352 is set at 1 indicating that a split packet has been received not in the expected order. In this way, the packet counter entry register 352 indicates the fact that a split packet has been received not in the expected order. Then, the receive control circuit 350 stores the updated contents of the packet counter entry register 352 back into the entry in the division packet counter 361 allocated to the transmitting node. Later on, the receive control circuit 350 generates an interrupt signal to the instruction processor 107 through the IP & memory-I/F circuit 153 to report the fact that a split packet has been received not in the expected order. From this interrupt signal, the instruction processor 107 recognizes an abnormality in the reception processing and typically carries out error handling. By carrying out the operations described above, the receiving node is capable of determining whether split packets arrive normally at the receiving node without providing a division flag field in the TCWB 360.

1. A parallel processor having a plurality of nodes connected to each other by a network, said parallel processor comprising:
a transmitting circuit for generating packets and transmitting said packets; and
a receiving circuit for determining whether each of said packets is normally received,
wherein each of said packets:
contains split data obtained as a result of splitting original data of a predetermined amount; and
includes information used by said receiving circuit for verifying normal reception of said packet.

2. A parallel processor according to claim 1, wherein said transmitting circuit comprises:
a first register for holding a maximum size of each of said packets to be transmitted;
a second register for storing said predetermined amount, which is decreased by said maximum size held in said first register each time one of said packets is transmitted;
a decision circuit for determining whether to split data to be transmitted on the basis of contents of said first register as well as said second register and for determining a size of any one of said packets to be transmitted to said network; and
a packet size register for holding said size.

3. A parallel processor according to claim 2, wherein:
there is further provided a memory including a transfer control word block used for exchanging data between said nodes;
said transmitting circuit further has:
a division flag address register for storing the address of a division flag in a receiving node specified in said transfer control word block; and
a receiving flag address register for storing the address of a receiving flag in a receiving node specified in said transfer control word block; and
said address of said division is to be included in the head of each of said packets.

4. A parallel processor according to claim 3, wherein said parallel processor further comprises a selector for selecting a buffer for holding said transfer control word block read out from said memory, said division flag address register or said receiving flag address register.

5. A parallel processor according to claim 4, wherein said selector selects said division flag when a middle one of said packets is received or said receiving flag when the last one of said packets is received.

6. A parallel processor according to claim 1, wherein said specified amount is used as the length of data included in a packet.

7. A parallel processor having a plurality of nodes connected to each other by a network, said parallel processor comprising:
a first means for generating packets and transmitting said packets; and
a second means for determining whether each of said packets is normally received,
wherein each of said packets:
contains a piece of split data obtained as a result of splitting original data of a predetermined amount; and
includes information used by said second means for verifying normal reception of said packet.

8. A parallel processor according to claim 7, wherein:
there is further provided a division flag region used for indicating whether or not each of said pieces of split data has been received normally;
said first means adds the address of said division flag region to the header of each of said packets; and
said address of said division flag region is updated each time one of said packets is transmitted.

9. A parallel processor according to claim 7, wherein said parallel processor further comprises:
an adding means, which is used for adding a sequence number to the header of each of said packets and is used for incrementing said sequence number by one each time said first means transmits one of said packets;
a counting means for counting the number of said packets received by said second means; and
a comparing means for comparing said sequence number with a packet count obtained as a result of counting the number of said packets received by said second means carried out by said counting means.

10. A parallel processing method adopted by a parallel processor having a plurality of nodes connected to each other by a network, said parallel processing method comprising the steps of:
generating packets and transmitting said packets; and
determining whether each of said packets is normally received,
wherein each of said packets:
contains a piece of split data obtained as a result of splitting original data of a predetermined amount; and
has a header including information used for verifying normal reception of said packet.

11. A parallel processing method according to claim 10, wherein said method further comprises the step of determining whether each of said packets has been received normally on the basis of said information.

12. A parallel processing method according to claim 10, wherein said step for generating the packets further comprises the steps of:
reading out a division flag address field, a receiving flag address field, the length of data to be transmitted and an SE field from a buffer used for storing a transfer control word block;
determining whether to split data to be transmitted into said packets in dependence on said SE field and on the basis of said length of data to be transmitted and a maximum size of each of said packets;
setting a proper size for each of said packets from a result of said determining step; and
reading out as much data to be transmitted as an amount determined by said set proper size.
